(19) United States
(12) Patent Application Publication
(10) Pub. No.: US 2012/0248666 A1
(43) Pub. Date: Oct. 4, 2012

(54) GAS SPRING AND DAMPER ASSEMBLY AND SUSPENSION SYSTEM INCLUDING SAME

(75) Inventors: Brian S. DeBruler, Tipton, IN (US); Todd E. Green, Cicero, IN (US)

(73) Assignee: FIRESTONE INDUSTRIAL PRODUCTS COMPANY, LLC, Indianapolis, IN (US)

(21) Appl. No.: 13/433,904

(22) Filed: Mar. 29, 2012

Related U.S. Application Data
(60) Provisional application No. 61/469,789, filed on Mar. 30, 2011.

(51) Int. Cl. B60G 15/12; F16F 9/088; B60G 17/015; F16F 9/05

(52) U.S. Cl. 267/64.24

(57) ABSTRACT

A gas spring and damper assembly includes a damper assembly and a gas spring assembly that are operatively connected to one another. The damper assembly includes a damper housing and a damper rod assembly. The gas spring assembly includes a first end member, a second end member and a flexible wall secured between the first and second end members to at least partially define a spring chamber. The assembly is displaceable between a collapsed condition and an extended condition. During use under load, the assembly can undergo displacement from the extended condition toward the collapsed condition upon transferring pressurized gas into the spring chamber, and can undergo displacement from the collapsed condition toward the extended condition upon transferring pressurized gas out of the spring chamber. A suspension system is also included.

This application claims the benefit of U.S. Provisional Application Ser. No. 61/469,789, filed Mar. 30, 2011, the disclosure of which is incorporated herein by reference in its entirety.

### BACKGROUND

The subject matter of the present disclosure broadly relates to the art of gas spring devices and, more particularly, to a gas spring and damper assembly that is capable of displacement from a first length condition toward a second length condition that is less than the first length condition upon filling of pressurized gas into the spring chamber of the gas spring and damper assembly. A suspension system including at least one of such gas spring and damper assemblies is also disclosed.

The subject matter of the present disclosure may find particular application and use in conjunction with suspension systems of wheeled vehicles, and may be described herein with specific reference thereto. However, it is to be appreciated that the subject matter of the present disclosure is also amenable to use in other applications and environments, and that the specific uses shown and described herein are merely exemplary. For example, the subject matter of the present disclosure could be used in support structures, height adjusting systems and/or actuators associated with industrial machinery, components thereof and/or other such equipment.

Coil spring and damper assemblies of a variety of types and kinds have been developed for use in connection with vehicle suspension system. Notwithstanding the wide usage and overall success of such coil spring and damper assemblies, it is believed desirable to develop gas spring and damper assemblies that can provide improved performance, additional features, reduced weight, reduced costs of manufacture, easier installation and/or other characteristics that may advance the art of gas spring devices.

### BRIEF SUMMARY

One example of a gas spring and damper assembly in accordance with the subject matter of the present disclosure can include a damper assembly and a gas spring assembly. The damper assembly can have a longitudinally-extending axis and can include a damper housing that includes a housing side wall extending axially between opposing first and second ends. A first housing end wall can extend across the housing side wall along the first end, and a second housing end wall can extend across the housing side wall along the second end. In this manner, the housing side wall and the first and second housing end walls together at least partially define a damping chamber containing a quantity of damping fluid. The damper assembly can also include a damper rod assembly that includes an elongated damper rod and a damper piston that is secured along the elongated damper rod. The damper rod assembly can be operatively interengaged with the damper housing for reciprocal displacement relative thereto with the damper piston disposed within the damping chamber and at least a portion of the elongated damper rod projecting axially-outwardly from the damper housing beyond the first housing end wall. The gas spring assembly can include a first end member supported in a substantially fixed position in spaced relation to the damper housing and slidably engaging the elongated damper rod. A second end member can be supported in substantially fixed position along the elongated damper rod during movement of the damper rod assembly in at least one axial direction. The second end member can be displaceable relative to the damper housing such that the second end member and the damper rod assembly can be concurrently displaced over a common distance during movement of the damper rod assembly in at least one direction. A flexible wall can be secured between the first and second end members to at least partially define a spring chamber. The assembly can be displaceable between a collapsed condition and an extended condition such that during use under load the assembly can undergo displacement from the extended condition toward the collapsed condition upon transferring pressurized gas into the spring chamber. Additionally, during use under load, the assembly can, optionally, undergo displacement from the collapsed condition toward the extended condition upon transferring pressurized gas out of the spring chamber.

One example of a suspension system in accordance with the subject matter of the present disclosure can include a gas spring and gas damper assembly according to the foregoing paragraph and a pressurized gas source in fluid communication with the spring chamber of the gas spring assembly.

### BRIEF DESCRIPTION OF THE DRAWINGS

FIG. 1 is a side elevation view of a conventional vehicle having a suspension system that includes a frame assembly with a frame and a rear fork pivotally supported on the frame.

FIG. 2 is an exploded perspective view of one example of a suspension system in accordance with the subject matter of the present disclosure including two gas spring and damper assemblies secured between the frame and rear fork of the frame assembly in FIG. 1.

FIG. 3 is a schematic representation of a suspension system in accordance with the subject matter of the present disclosure including a gas spring and damper assembly and pressurized gas system.

FIG. 4 is a top perspective view, in partial cross section, of one example of a gas spring and damper assembly in accordance with the subject matter of the present disclosure.

FIG. 5 is a bottom perspective view of the exemplary gas spring and damper assembly in FIG. 4.

FIG. 6 a side view, in partial cross section, of the exemplary gas spring and damper assembly in FIGS. 4 and 5.

FIG. 7 is an enlarged view of the portion of the gas spring and damper assembly in FIGS. 4-6 identified in Detail 7 of FIG. 6.

FIG. 8 is an enlarged view of the portion of the gas spring and damper assembly in FIGS. 4-6 identified in Detail 8 of FIG. 6.

### DETAILED DESCRIPTION

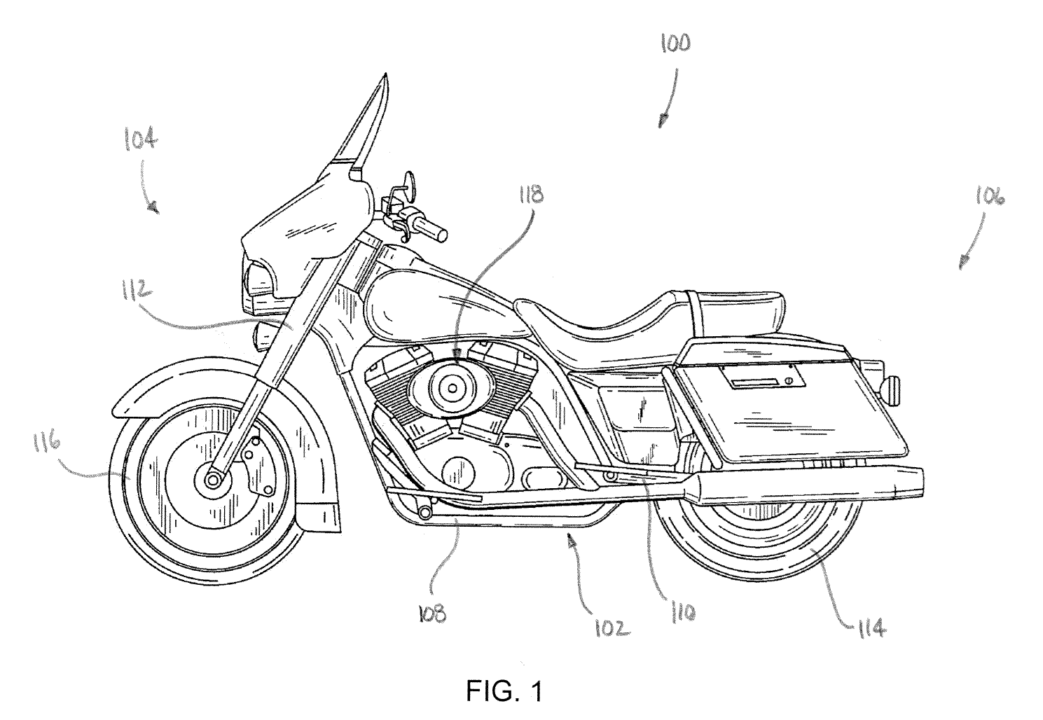

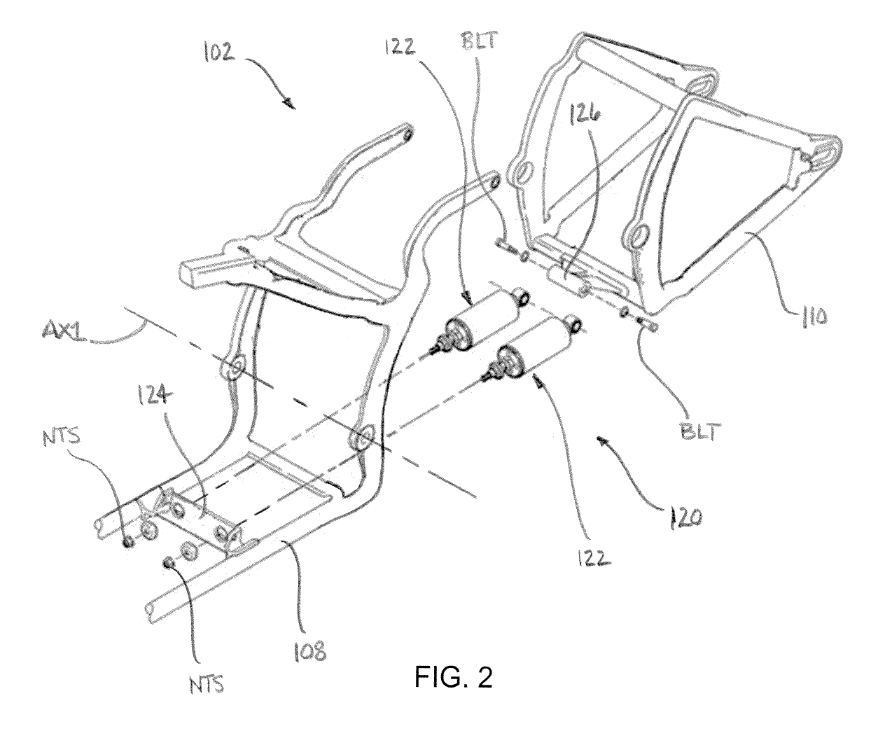

Turning now to the drawings, wherein the showings are for the purpose of illustrating examples of the subject matter of the present disclosure and which are not intended as a limitation of the same, FIG. 1 illustrates one example of a vehicle 100, such as a two or three wheeled vehicle, for example, that includes two or more suspension components with a suspension system operatively disposed therebetween. In the exemplary arrangement in FIGS. 1 and 2, vehicle 100 is shown as taking the form of a motorcycle that includes a frame assembly 102 that extends in a lengthwise direction between front and rear ends 104 and 106. Frame assembly 102 includes a frame 108, a rear fork 110 and a front fork assembly 112.

Rear fork 110 is pivotally secured to frame 108 toward end 106 for rotation about an axis AX1 (FIG. 2) that extends in a widthwise direction that is transverse to the lengthwise direction. Front fork assembly 112 is pivotally secured to frame 108 toward end 104 for rotation relative to the frame in a conventional manner. A rear wheel 114 is secured along rear fork 110 and a front wheel 116 is secured along front fork assembly 112. It will be appreciated that wheels 114 and 116 can be operatively connected to the rear fork and the front fork assembly, respectively, in any suitable manner, such as may be well known to those of skill in the art.

Vehicle 100 can also include an engine 118, such as an internal combustion engine, for example. A transmission (not numbered), such as a drive chain or drive belt arrangement, for example, can be operatively connected between the engine and one or more of the wheels to provide motive power to the vehicle. Vehicle 100 can also, optionally, include an electrical power source (not numbered), such as an alternator and/or a battery, for example, that may be suitable for generating or otherwise providing electrical power to one or more components and/or systems of vehicle 100.

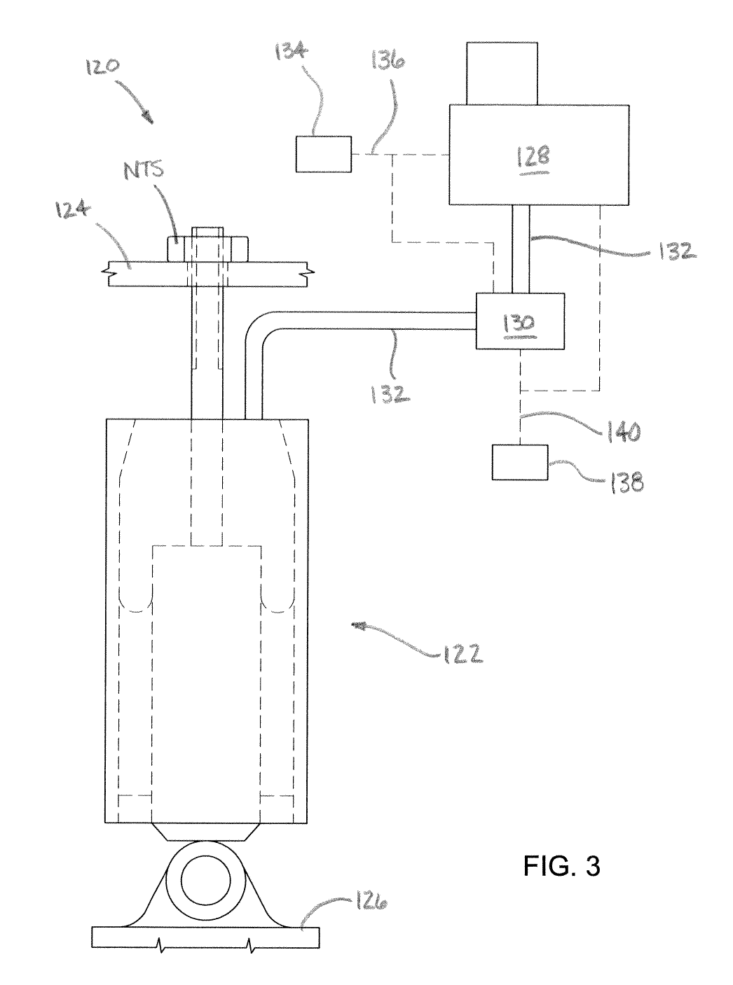

Vehicle 100 can also include a suspension system 120, which can include one or more gas spring and damper assemblies in accordance with the subject matter of the present disclosure. Suspension system 120 is shown in FIG. 2 as including two gas spring and damper assemblies 122 (only one of which is shown in FIG. 3) that are adapted for operative connection between frame 108 and rear fork 110 of vehicle 112. Though only one gas spring and damper assembly is shown in FIG. 3, it will be appreciated that suspension system 120 can include any suitable number of one or more gas spring and damper assemblies, such as a quantity of from one to twenty gas spring and damper assemblies, for example.

Gas spring and damper assemblies 122 are shown in FIGS. 2 and 3 as being secured between opposing mounting portions of frame 108 and rear fork 110. In the exemplary arrangements shown, frame 108 can include a cross member 124 and rear fork 110 can include a pivot mount 126. Gas spring and damper assemblies 122 are operatively connected between cross member 124 and pivot mount 126 such that the assemblies extend and compress as the frame and rear fork pivot relative to one another about axis AX1.

Suspension system 120 can also include other, optional, components and/or systems for use in operative association with gas spring and damper assemblies 122. For example, the suspension system can optionally include a pressurized gas source, such as a compressor 128, for example, that can be selectively operated to supply pressurized gas to the one or more gas spring and damper assemblies. In some cases, compressor 128 can operate as a control device that functions to selectively transfer pressurized gas into and out of assemblies 122. In which case, the compressor can be in direct fluid communication with the gas spring and damper assembly, such as by way of a pressurized gas line (not shown) and suitable connector fitting (not shown).

In other cases, a separate control device can be used, such as a valve assembly 130, for example. If included, valve assembly 130 can be placed in fluid communication between one or more of assemblies 122 and compressor 128 in any suitable manner, such as by way of pressurized gas lines 132, for example. Valve assembly 130 can be selectively operated to permit pressurized gas transfer into and out of the gas spring and damper assembly. Additionally, an exhaust element (not shown) can optionally be included in fluid communication with compressor 128 and/or valve assembly 130, and selectively placed in fluid communication with one or more of assemblies 122 for venting pressurized gas therefrom. Furthermore, a storage reservoir or pressurized gas tank (not shown) can optionally be included in fluid communication with one or more of the aforementioned components and/or assemblies.

Suspension system 120 can also include a control system (not numbered) that can include any suitable sensors, switches, and/or controllers for selectively operating the pressurized gas source and/or the one or more (optional) control devices, if included. For example, suspension system 120 can optionally include a manual switch 134 that is selectively operable to energize or otherwise place compressor 128 and/or valve assembly 130 in electrical communication with an electrical power source, such as an alternator, battery or other system of vehicle 100, for example. Manual switch 134 can be communicatively coupled with compressor 128 and/or valve assembly 130 in any suitable manner, such as by way of one or more wires or other signal conductors 136, for example. In this manner, compressor 128 (and/or valve assembly 130) could be selectively operated to transfer pressurized gas into one or more of assemblies 102, such as through valve assembly 130 and pressurized gas lines 132, for example.

Additionally, or in the alternative, suspension system 120 can optionally include a height or distance sensor 138 that is operative to selectively energize or otherwise place compressor 104 and/or valve assembly 106 in electrical communication with an electrical power source, such as due to changes in vehicle height, for example. It will be appreciated that any such optional height sensors or any other distance-determining devices, if provided, can be of any suitable type, kind, construction and/or configuration, such as mechanical linkage sensors, ultrasonic wave sensors or electromagnetic wave sensors, such as may respectively operate using ultrasonic or electromagnetic waves, for example. Sensor 138, if provided, can be communicatively coupled with compressor 128 and/or valve assembly 130 in any suitable manner, such as by way of one or more wires or other signal conductors 140, for example.

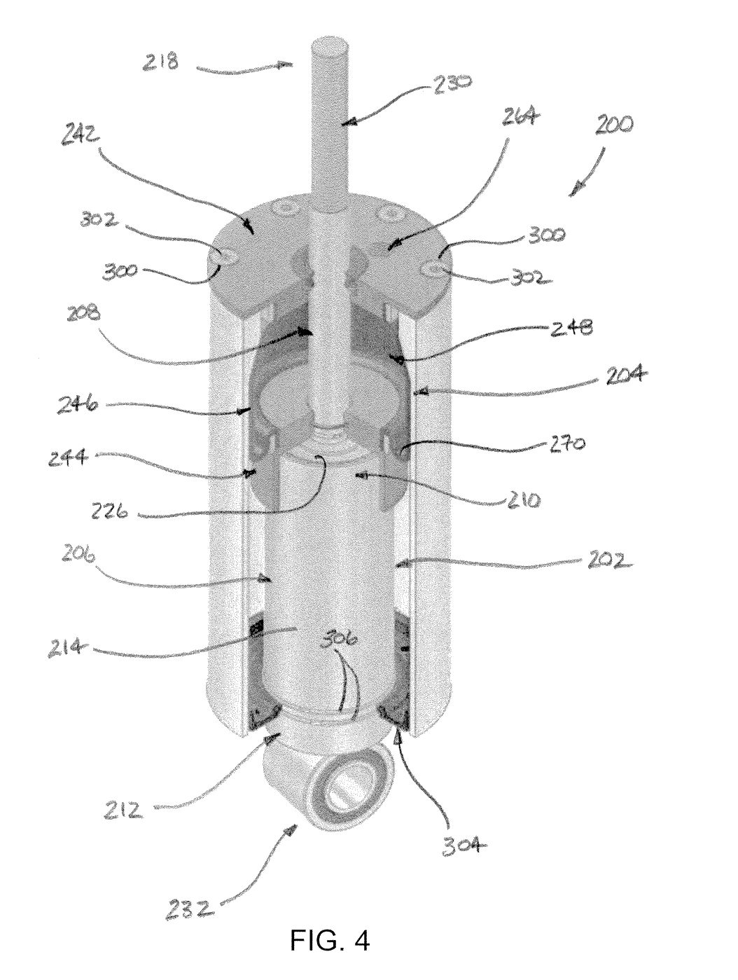

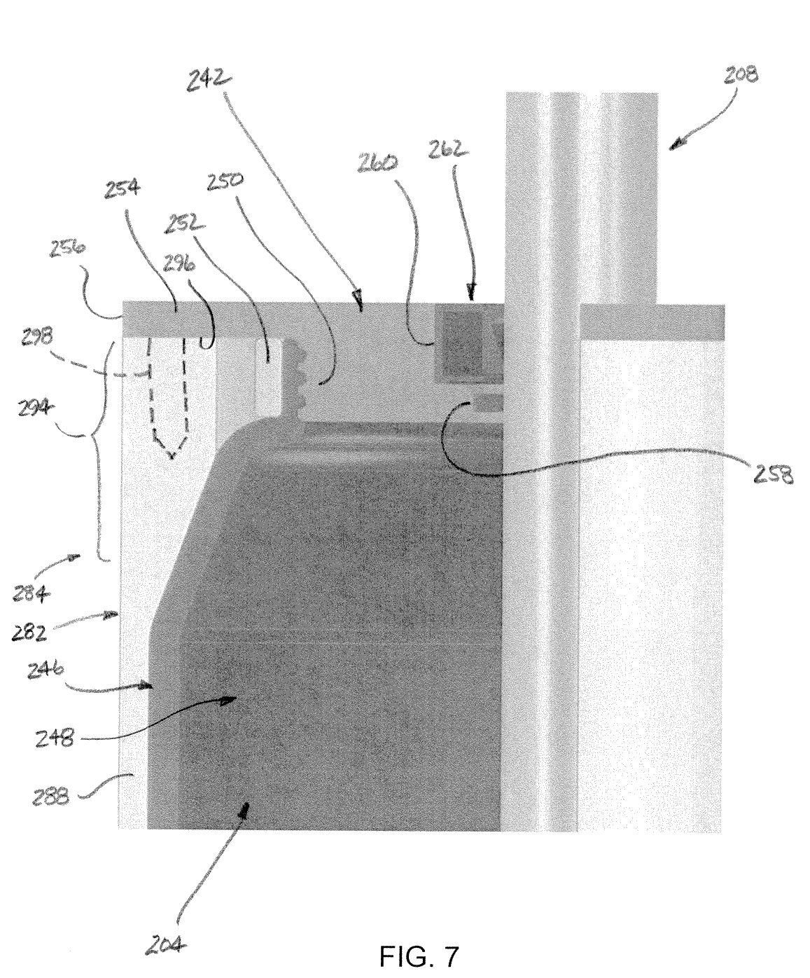

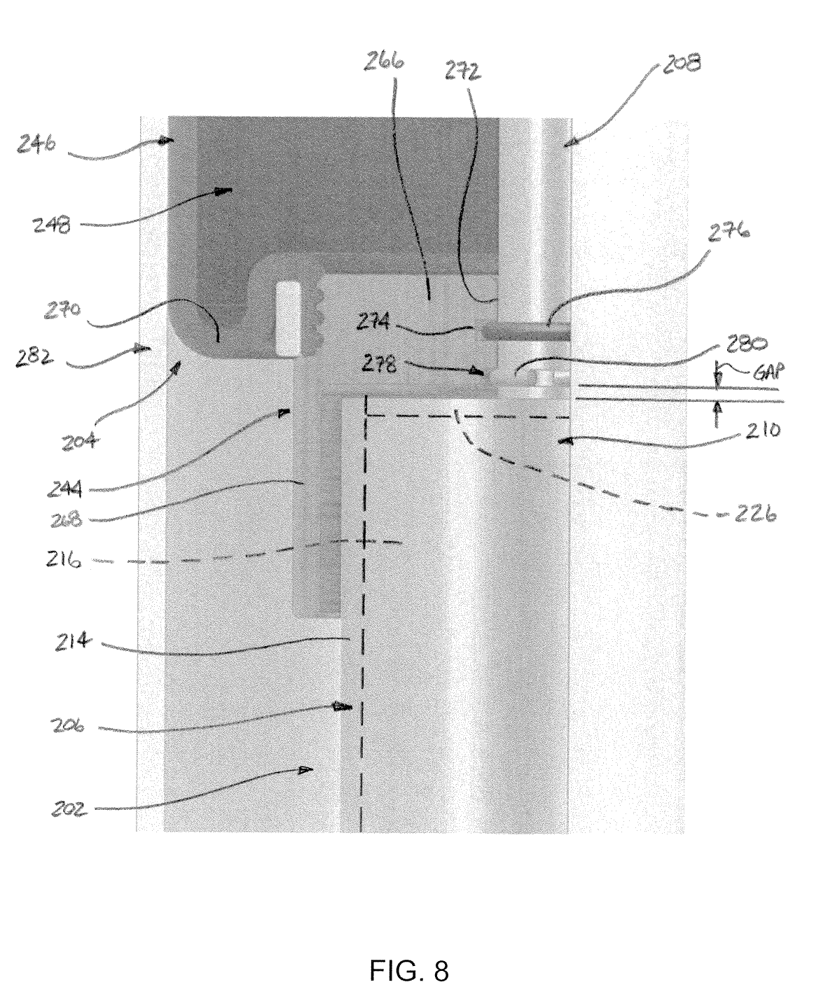

Having described an example of a suspension system (e.g., suspension system 120) that can include a gas spring and damper assembly in accordance with the subject matter of the present disclosure, one example of such a gas spring and damper assembly will now be described in connection with FIGS. 4-8. As shown therein, one example of a gas spring and damper assembly 200, such as may be suitable for use as a gas spring and damper assembly 122 in FIGS. 2 and 3, for example, is shown as including a damper assembly 202 and a gas spring assembly 204 that is operatively connected with the damper assembly. It will be appreciated that, in use, gas spring and damper assembly 200 can undergo changes in length (i.e., can be displaced between extended and collapsed conditions) as a suspension system within which one or more assemblies are installed dynamically moves to accommodate forces and/or inputs acting on the vehicle.

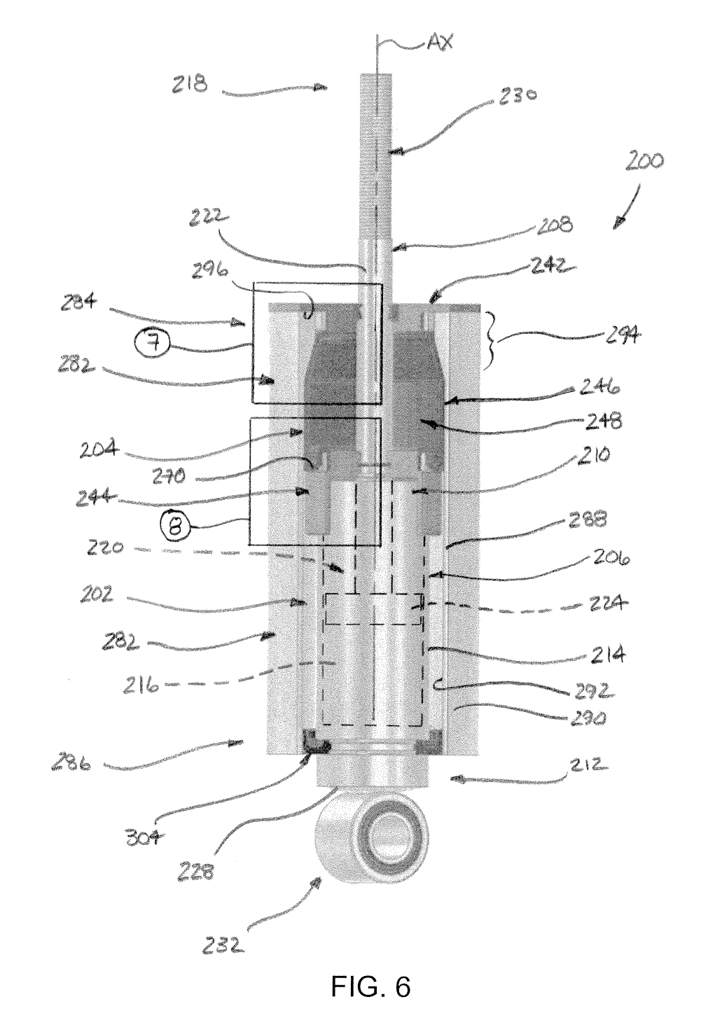

Damper assembly 202 is shown in FIGS. 4-8 as having an axis AX (FIG. 6) and including a damper housing 206 and a damper rod assembly 208 that is at least partially received in the damper housing. Damper housing 206 extends axially between opposing housing ends 210 and 212, and includes a housing wall 214 that at least partially defines a damping chamber 216 (FIG. 6). Damper rod assembly 208 extends lengthwise between opposing ends 218 and 220 (FIG. 6) and includes an elongated rod 222 and a damper piston 224 (FIG. 6) disposed along end 220 of damper rod assembly 208. Damper piston 224 is received within damping chamber 216 of damper housing 206 for reciprocal movement along the housing wall in a conventional manner. A quantity of damping fluid (not shown) can be disposed within damping chamber and damper piston 224 can be displaced through the damping fluid to dissipate kinetic energy acting on gas spring and damper assembly 200.

Housing wall 214 can form an opening (not shown) along housing end 210. A damper end wall 226 can extend across the opening and can be secured on or along housing wall 214 such that a substantially fluid-tight connection is formed therebetween. Damper end wall 226 can include an opening (not shown) and elongated rod 222 can extend axially-outwardly from damping chamber 212 through the opening in a direction opposite housing end 212. Additionally, a damper end wall 228 can be connected across end 212 of damper housing 206 such that a substantially fluid-tight connection is formed therebetween.

Elongated rod 222 projects outwardly from damper end wall 226 such end 218 of the elongated rod is outwardly exposed from the damper housing and is accessible. A connection feature 230, such as a plurality of threads, for example, can be provided on or along the elongated rod for use in operatively connecting gas spring and damper assembly 200 to an associated vehicle structure, such as cross member 124 of frame 108 in FIGS. 1-3, for example. In such case, one or more corresponding securement devices, such as threaded nuts NTS (FIGS. 2 and 3), for example, can engage connection feature 230 and thereby operatively interconnect damper rod 208 with an associated structural component, such as frame 108, for example.

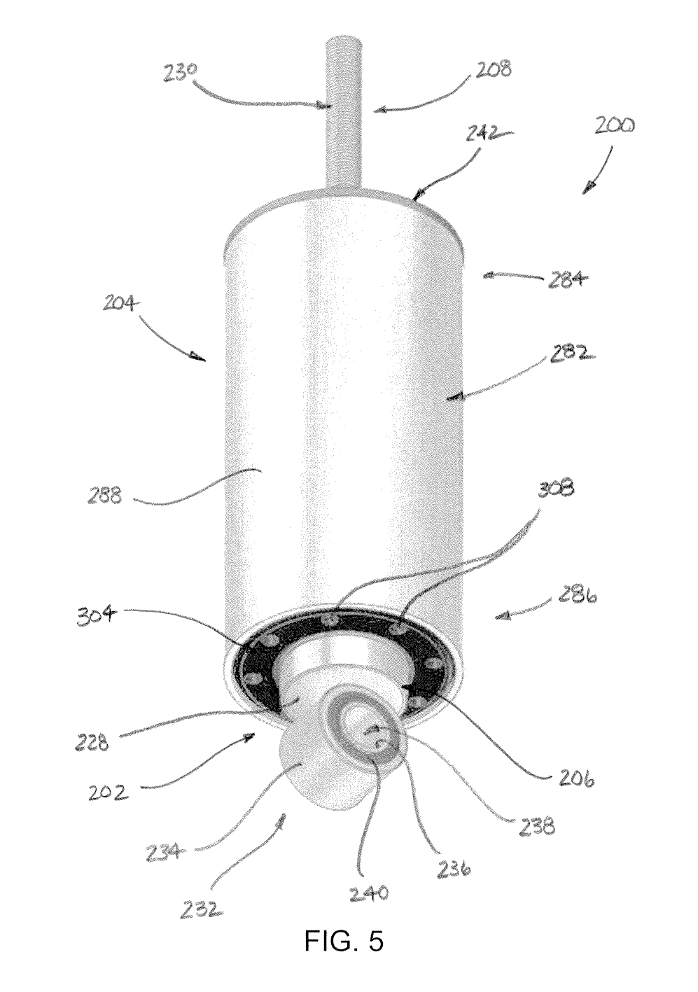

Damper assembly 202 also includes a connection feature 232, such as a pivot or bearing mount, for example, that is operatively disposed along damper housing 206 and is adapted to operatively connect damper housing 206 to an associated vehicle structure, such as pivot mount 126 of rear fork 110, for example. As identified in FIG. 5, for example, connection feature 232 can include an outer sleeve 234, an inner sleeve 236 that at least partially defines a mounting passage 238 and an intermediate element 240, such as an elastomeric bushing or a friction-reducing bearing operatively connected between the inner and outer sleeves. It will be appreciated that the connection feature can be secured on or along the associated vehicle structure in any suitable manner. As one example, threaded fasteners, such as shoulder bolts BLT (FIG. 2), can extend through mounting passage 238 in the bearing mount and threadably engage the pivot mount.

Gas spring assembly 204 includes an end member 242, such as a top cap, for example, and an end member 244, such as a roll-off piston, for example, that can be disposed in axially-spaced relation to one another. A flexible wall, such as a flexible sleeve 246, for example, can be operatively connected between end members 242 and 244 in a substantially fluid-tight manner such that a spring chamber 248 is at least partially defined therebetween.

End member 242 is shown in FIGS. 4-7 as including an inner wall portion 250 along which one end of flexible sleeve 246 is operatively connected, such as, for example, through the use of a retaining ring 252 that can be crimped radially-inwardly or otherwise deformed to form a substantially fluid-tight connection therebetween. End member 242 can also include an outer wall portion 254 that projects radially-outwardly from inner wall portion 250 to an outer peripheral edge 256. A passage wall 258 at least partially defines a passage (not numbered) that extends through end member 242 and is dimensioned to permit elongated rod 222 to pass therethrough. A recess wall 260 can be included adjacent passage wall 258 to form a recess (not numbered) for receiving and retaining a sealing element 262 that operatively interengages an outer surface (not numbered) of elongated rod 222 to form a substantially fluid-tight seal therewith. However, it will be recognized that sealing element 262 permits elongated rod 222 to slidably translate into and out of the gas spring assembly through end member 242. Additionally, a fluid transfer passage or port 264 (FIG. 4) can extend through end member 242 such that fluid communication into and out of spring chamber 248 can be achieved. Port 264 can be adapted to receive a suitable connector fitting (not shown), such as may be suitable for operatively connecting pressurized gas line 132 (FIG. 3) to the gas spring and damper assembly.

End member 244 is shown in FIGS. 4-6 and 8 as including a first or upper wall portion 266 along which another end of flexible sleeve 246 is operatively connected. End member 244 also includes a second or side wall portion 268 that extends axially (i.e., longitudinally) from first wall portion 266 in a direction toward end 212 of damper housing 206. In the assembled condition shown in FIGS. 4-8, a portion of flexible sleeve 246 forms a rolling-lobe 270 that is displaced along side wall portion 268 as the gas spring and damper assembly undergoes changes in overall height, such as, for example, may be due to variations in load conditions applied thereto and/or variations in pressurized gas volume within the spring chamber. It will be recognized that a wide variety of shapes, profiles and/or configurations can and have been used in forming the second or side wall portion of end members, such as gas spring pistons. As such, it will be appreciated that the profile of side wall portion 268 is merely exemplary.

End member 244 also includes a passage wall 272 that at least partially defines a passage (not numbered) extending through the end member and is dimensioned to permit elongated rod 222 to pass therethrough. A first groove wall 274 can be included along passage wall 272 to form a groove (not numbered) for receiving and retaining a sealing element 276 that operatively interengages the outer surface (not numbered) of elongated rod 222 to form a substantially fluid-tight seal therewith. It will be recognized that the interengagement between sealing element 276 and elongated rod 222 will permit end member 244 and elongated rod 222 to slidably translate relative to one another while maintaining a substantially fluid-tight seal therebetween.

However, damper assembly 202 includes a travel-limiting element or feature disposed on or along the damper rod assembly that limits the travel of the end member (e.g., end member 244) along the elongated rod. Additionally, it will be appreciated that in an inflated condition, pressurized gas acting against end member 244 will bias the end member into abutting engagement with the travel-limiting element. As such, in an inflated condition, damper rod assembly 208 and end member 244 will be maintained and, thus, be displaced in generally fixed relation to one another.

In the exemplary arrangement shown in FIGS. 4, 6 and 8, elongated rod 222 includes a groove wall (not numbered) that is recessed into the elongated rod and at least partially defines a groove 278 that receives a retaining element 280, such as a retaining ring, for example. The retaining element projects outwardly beyond the outer surface of elongated rod 222 and abuttingly engages upper wall portion 266 of end member 244, which thereby limits the distance along the elongated rod that the end member can travel. In one exemplary embodiment, the retaining element is positioned adjacent but in spaced relation to damper end wall 226 along end 210 of the damper housing when the damper rod is in a fully retracted (or fully collapsed) position. In this manner, upper wall portion 266 of end member 244 can be supported in spaced relation to the damper end wall when the gas spring and damper assembly is in a full compressed condition, such that a gap GAP is provided between end member 244 and the damper housing.

Gas spring and damper assembly 200 also includes a restraining cylinder 282 that extends longitudinally along damper assembly 202 and gas spring assembly 204 between opposing ends 284 and 286. Restraining cylinder 282 includes a cylinder wall 288 that can have an outer surface 290, which is shown as being in approximate alignment with outer peripheral edge 256 of end member 242, and an inner surface 292 that is disposed in outwardly spaced relation to housing wall 214 and in abutting engagement with flexible sleeve 246. Cylinder wall 288 includes a mounting region 294 that is formed along end 284 that has an increased wall thickness relative to a remaining portion of cylinder wall 288. Mounting region 294 terminates at an end wall 296 that is shown as being approximately planar and extends transverse to axis AX. In a preferred arrangement, end wall 296 is dimensioned to abuttingly engage outer wall portion 254 of end member 242.

The restraining cylinder is operatively connected between end member 242 of the gas spring assembly and the damper housing of the damper assembly. In a preferred arrangement, the restraining cylinder is formed from a material that is substantially inelastic in the longitudinal direction (i.e., an elongating axial direction), such as metal or rigid plastic, for example. In this manner, end member 242 and the damper housing can be maintained in a substantially fixed position relative to one another.

In the exemplary arrangement shown in FIGS. 4-8, restraining cylinder 282 can be formed from a metal material, such as aluminum or steel, for example, and can be secured on or along end member 242 and damper housing 206 in any suitable manner. For example, mounting region 294 of cylinder wall 288 can include a plurality of threaded passages 298 that extend axially into the mounting region from along end wall 296. End member 242 can include one or more passages 300 that extend through outer wall portion 254 in approximate alignment with one of threaded passages 298. In such case, one or more threaded fasteners 302 can extend through passages 300 and threadably engage a corresponding one of threaded passages 298. In this manner, end 284 of restraining cylinder 282 can be secured in abutting engagement with end member 242 along outer wall portion 254 thereof. It will be appreciated, however, that other configurations and/or arrangements could alternately be used.

Additionally, end 286 of restraining cylinder 282 can be secured on or along damper housing 206 in any suitable manner. For example, one or more support elements can be provided on or along the housing wall of the damper housing. The support element(s) can operatively connect the restraining cylinder to the damper housing such that the restraining cylinder is fixedly attached to the damper housing. As one example, a support ring 304 can be provided separately from damper housing 206 and restraining cylinder 282, and can be secured therebetween in a suitable manner. Alternately, a feature corresponding to the support ring could be formed in a suitable position on or along one of the damper housing and the restraining cylinder. In which case, the feature could be secured on or along the other of the damper housing and the restraining cylinder.

One example of a suitable arrangement for operatively interconnecting the restraining cylinder and the damper housing the support ring is shown in FIGS. 4-6. It will be appreciated, however, that other arrangements could alternately be used. More specifically, damper housing 206 can include one or more groove walls (not shown) that at least partially define a corresponding number of one or more grooves (not shown) that extend radially inwardly into housing wall 214. One or more retaining elements, such as retaining rings 306, for example, can be at least partially received within the grooves and project radially outwardly beyond the outer surface of housing wall. Support ring 304 can include an inner wall (not numbered) that forms a mounting passage (not numbered) that is dimensioned to fit over the housing wall and abuttingly engage retaining rings 306. In this manner, support ring 304 can be secured in an axially-fixed position along damper housing 206.

Support ring 304 can also include an outer wall (not numbered) having a plurality of external threads (not numbered) that threadably engage a corresponding plurality of threads formed along inner surface 292 of the restraining cylinder. One or more ports or vent passages 308 (FIG. 5) can be provided through support ring 304 to minimize pressure buildup within the gas spring and damper assembly outside of spring chamber 248.

In use, spring chamber 248 of gas spring assembly 204 contains a quantity of pressurized gas. As the gas spring and damper assembly moves from a collapsed condition, such as is shown in FIGS. 4-8, toward an extended condition (not shown) in which assembly 200 will have an increased length, damper rod assembly 208 translates or is otherwise linearly displaced out of damper housing 206. As discussed above, end member 244 is urged by the pressurized gas within the spring chamber into abutting engagement with retaining element 280. As such, as damper rod assembly 208 translates out of damper housing 206, end member 224 is displaced from an initial position in a direction away from the damper housing and toward end member 242 due to the interengagement of end member 244 with the retaining element. In this manner, damper rod assembly 208 and end member 244 are concurrently displaced over a common distance during movement of the damper rod assembly. It will be appreciated that such common displacement will occur during movement in at least one axial direction.

As the gas spring and damper assembly moves from an extended condition back toward a collapsed condition, damper rod assembly 208 translates or is otherwise linearly displaced back into damper housing 206 and end member 244 is urged toward the damper housing by the pressurized gas within the spring chamber. In this manner, pressurizing the gas spring and damper assembly can function to collapse the assembly, such as for installation and/or maintenance operations, for example. Additionally, as with conventional gas spring and damper assemblies, the nominal operating length of assembly 200 can be varied during use by increasing the volume of air within the assembly. However, assembly 200 differs from conventional constructions in that increasing the volume of pressurized gas within the spring chamber during use will tend to reduce the overall length of the assembly, whereas conventional assemblies would be expected to increase in length. And, assembly 200 differs from conventional constructions in that decreasing the volume of pressurized gas within the spring chamber, during use, will tend to increase the overall length of the assembly, whereas conventional assemblies would be expected to decrease in length.

In this manner, the operative length of assembly 200 can be selectively adjusted by increasing or decreasing the volume of pressurized gas within the spring chamber. In some cases, such selective adjustment of the length of assembly 200 can operate or otherwise function to vary the relative position of the associated suspension components and thereby alter the height of a vehicle.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation.

Furthermore, the phrase “flowed-material joint” and the like, if used herein, are to be interpreted to include any joint or connection in which a liquid or otherwise flowable material (e.g., a melted metal or combination of melted metals) is deposited or otherwise presented between adjacent component parts and operative to form a fixed and substantially fluid-tight connection therebetween. Examples of processes that can be used to form such a flowed-material joint include, without limitation, welding processes, brazing processes and soldering processes. In such cases, one or more metal materials and/or alloys can be used to form such a flowed-material joint, in addition to any material from the component parts themselves. Another example of a process that can be used to form a flowed-material joint includes applying, depositing or otherwise presenting an adhesive between adjacent component parts that is operative to form a fixed and substantially fluid-tight connection therebetween. In such case, it will be appreciated that any suitable adhesive material or combination of materials can be used, such as one-part and/or two-part epoxies, for example.

Further still, the term “gas” is used herein to broadly refer to any gaseous or vaporous fluid. Most commonly, air is used as the working medium of gas spring devices, such as those described herein, as well as suspension systems and other components thereof. However, it will be understood that any suitable gaseous fluid could alternately be used.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. A gas spring and damper assembly comprising:
a damper assembly having a longitudinally-extending axis and including:
a damper housing including a housing side wall extending axially between opposing first and second ends, a first housing end wall extending across said housing side wall along said first end, and a second housing end wall extending across said housing side wall along said second end such that said housing side wall and said first and second housing end walls together at least partially define a damping chamber containing a quantity of damping fluid; and,
a damper rod assembly including an elongated damper rod and a damper piston secured along said elongated damper rod, said damper rod assembly operatively interengaged with said damper housing for reciprocal displacement relative thereto with said damper piston disposed within said damping chamber and at least a portion of said elongated damper rod projecting axially-outwardly from said damper housing beyond said first housing end wall; and,
a gas spring assembly including:
a first end member supported in a substantially fixed position in spaced relation to said damper housing and slidably engaging said elongated damper rod;
a second end member supported in substantially fixed position along said elongated damper rod during movement of said damper rod assembly in at least one axial direction, said second end member displaceable relative to said damper housing such that said second end member and said damper rod assembly are concurrently displaced over a common distance during movement of said damper rod assembly in at least one direction; and,
a flexible wall secured between said first and second end members to at least partially define a spring chamber; and,
said assembly being displaceable between a collapsed condition and an extended condition such that during use under load:
said assembly can undergo displacement from said extended condition toward said collapsed condition upon transferring pressurized gas into said spring chamber; and,
said assembly can undergo displacement from said collapsed condition toward said extended condition upon transferring pressurized gas out of said spring chamber.

2. A gas spring and damper assembly according to claim 1, wherein said damper assembly is displaceable between a fully collapsed condition and a fully extended condition, and said second end member includes end wall and is supported in substantially fixed positioned along said elongated damper rod such that in said fully collapsed condition of said damper assembly said end wall of said second end member is spaced apart from said first housing end wall such that a gap is defined therebetween.

3. A gas spring and damper assembly according to claim 1 further comprising a restraining cylinder including an endless annular wall extending peripherally about said axis and lengthwise between opposing ends, said annular wall including an inside surface disposed in abutting engagement with said flexible wall.

4. A gas spring and damper assembly according to claim 3, wherein said restraining cylinder is fixedly attached to at least one of first end member and damper housing.

5. A gas spring and damper assembly according to claim 4, wherein said annular wall includes a first wall thickness and a mounting region disposed along one of said opposing ends having a second wall thickness that is greater than said first wall thickness.

6. A gas spring and damper assembly according to claim 5, wherein said mounting region of said annular wall includes a plurality of axially-extending threaded passages, said first end member includes a plurality of clearance passages extending therethrough with at least one of said plurality of clearance passages disposed in approximate alignment with one of said plurality of threaded passages, and at least one threaded fastener extending through a clearance passage an threadably engaging a corresponding threaded passage to fixedly attach said restraining cylinder to said first end member.

7. A gas spring and damper assembly according to claim 4 further comprising a support ring extending peripherally about an outer surface of said housing wall, and disposed between said damper housing and said restraining cylinder.

8. A gas spring and damper assembly according to claim 7, wherein an inside surface of said annular wall of said restraining cylinder includes a plurality of threads, and said support ring includes an outside surface including a corresponding plurality of threads such that said restraining cylinder and said support ring can be secured together by interengaging said pluralities of threads.

9. A gas spring and damper assembly according to claim 7, wherein said housing wall includes an endless annular groove extending radially-inwardly into said housing wall with a retaining element received within said groove and projecting radially-outwardly beyond said outer surface of said housing wall, said support ring disposed in abutting engagement with said retaining element such that said support ring is retained along outer surface of damper housing in at least one axial direction.

10. A gas spring and damper assembly according to claim 7, wherein said support ring includes one or more vent passages extending therethrough.

11. A gas spring and damper assembly according to claim 1, wherein second end member is a roll-off piston and includes an outer side wall with said flexible wall forming a rolling lobe along said outer side wall.

12. A gas spring and damper assembly according to claim 1, wherein said gas spring assembly includes a sealing element fluidically disposed between said first end member and an outer surface of said elongated damper rod such that a substantially fluid-tight seal is formed therebetween.

13. A gas spring and damper assembly according to claim 1, wherein said gas spring assembly includes a sealing element fluidically disposed between said second end member and an outer surface of said elongated damper rod such that a substantially fluid-tight seal is formed therebetween.

14. A suspension system comprising:
a gas spring and damper assembly according to claim 1;
a pressurized gas source in fluid communication with said spring chamber of said gas spring assembly.

15. A suspension system according to claim 14, wherein said gas spring and damper assembly is a first gas spring and damper assembly, and said suspension system further comprises a second gas spring and damper assembly with said pressurized gas source in fluid communication with at least one of said first and second gas spring and damper assemblies.

16. A suspension system according to claim 14 further comprising a valve assembly in fluid communication between said spring chamber of said gas spring and damper assembly and said pressurized gas source.

17. A suspension system according to claim 16 further comprising a control system communicatively coupled with at least said valve assembly and operative to selectively actuate said valve assembly between an open condition and a closed condition.

18. A suspension system according to claim 17, wherein said control system includes a manually-actuatable switch for selectively energizing said valve assembly.

19. A suspension system according to claim 17, wherein said control system includes a distance-sensing device operative selectively energize said valve assembly.

20. A suspension system according to claim 14, wherein said damper assembly is displaceable between a fully collapsed condition and a fully extended condition, and said second end member includes end wall and is supported in substantially fixed positioned along said elongated damper rod such that in said fully collapsed condition of said damper assembly said end wall of said second end member is spaced apart from said first housing end wall such that a gap is defined therebetween.
